(19) United States
(12) Patent Application Publication
(10) Pub. No.: US 2016/0246287 A1
(43) Pub. Date: Aug. 25, 2016

(54) PROBABILISTIC EVALUATION OF TURBOMACHINERY DESIGN TO PREDICT HIGH CYCLE FATIGUE FAILURE

(71) Applicant: Rolls-Royce Corporation, Indianapolis, IN (US)

(72) Inventor: Girish Modgil, Carmel, IN (US)

(21) Appl. No.: 14/606,382

(22) Filed: Jan. 27, 2015

Related U.S. Application Data
(60) Provisional application No. 61/952,536, filed on Mar. 13, 2014.

(51) Int. Cl. G05B 19/4065

(52) U.S. Cl. CPC G05B 19/4065; G05B 2219/39247

(57) ABSTRACT

Technologies for evaluating the design of a turbomachinery component for risk of failure due to high cycle fatigue via test data developed as a result of simulations executed by high fidelity aeromechanics models towards the development of a probabilistic Goodman diagram.

### CROSS-REFERENCE TO RELATED APPLICATION

This application claims the benefit of and priority to U.S. Provisional Patent Application Ser. No. 61/952,536, filed Mar. 13, 2014, which is incorporated herein by this reference in its entirety.

### FIELD OF THE DISCLOSURE

The present disclosure relates generally to the fields of materials science and fatigue, and more particularly to the design of turbomachinery, such as turbine blades for gas turbine engines. Additionally, the present disclosure relates to the application of probabilistic techniques to assess the risk of failure of a turbomachinery blade due to high cycle fatigue.

### BACKGROUND

Reliable operation of a gas turbine engine depends on the structural integrity of its rotating parts. Over the last fifty years, technological advancements in the design of gas turbine engines for aerospace applications have resulted in improved fuel consumption, higher thrust-to-weight ratio, lower noise, and reduced emissions, all while maintaining reliability and affordability. While achieving these objectives, new engine designs can increase the risk of failure due to high cycle fatigue (HCF). HCF failure can occur if the combinations of vibratory and steady stress levels exceed the material limit.

The vibratory stress contribution to the HCF failure is due to forced response vibration. A Goodman diagram can be used to visually depict the limiting combinations of vibratory and steady stresses; however, failures resulting from forced response vibration are difficult to predict. An analysis of forced response vibration, referred to as a forced response analysis (or aeromechanics analysis), requires knowledge of aerodynamics, stress, structural dynamics and aeroelasticity. Each of these aspects of the analysis can be computationally expensive and the analysis requires experts from multiple disciplines. A typical aeromechanics calculation can take up to two weeks. As a result, the turbine blade design stage does not include forced response analysis. In fact, high-fidelity aeromechanics analyses are typically performed at the end of the design process, when it is very costly to make significant changes to the blade geometry or aerodynamic design.

### SUMMARY

The present application discloses one or more of the features recited in the appended claims and/or the following features which, alone or in any combination, may comprise patentable subject matter.

In an example 1, according to at least one embodiment of this disclosure, a method for evaluating a turbomachinery blade design for risk of high cycle fatigue includes, with at least one computing device: selecting a plurality of random variables, each random variable corresponding to a parameter of a high-fidelity aeromechanics model; for each selected random variable, creating a subset of test data, the test data resulting from simulations performed by the high-fidelity aeromechanics model; estimating vibratory stress and steady stress uncertainties using the set of test data for each random variable; and generating a probabilistic Goodman diagram incorporating the estimated uncertainties. An example 2 includes the subject matter of example 1, and further includes creating the subset of test data by non-random sampling. An example 3 includes the subject matter of example 1 or example 2, and further includes creating the subset of test data by executing a generalized polynomial chaos sampling method. An example 4 includes the subject matter of any of examples 1-3, including determining a probability distribution function for vibratory stress based on the estimated vibratory stress and steady stress uncertainties. An example 5 includes the subject matter of any of the preceding examples, including generating a cumulative probability distribution function for vibratory stress. An example 6 includes the subject matter of any of the preceding examples, including predicting a risk of failure of the turbomachinery blade design due to high cycle frequency based on the probabilistic Goodman diagram. An example 7 includes the subject matter of any of the preceding examples, including generating a reliability assessment for the turbomachinery blade design based on the probabilistic Goodman diagram. An example 8 includes the subject matter of any of the preceding examples, including developing a probabilistic contour map from the probabilistic Goodman diagram. In an example 9, a computing device includes a processor and memory having stored therein a plurality of instructions that when executed by the processor cause the computing device to perform the method of any of claims 1-8. In an example 10, one or more machine readable storage media including a plurality of instructions stored thereon that in response to being executed result in a computing device performing the method of any of claims 1-8.

In an example 11, according to at least one embodiment of this disclosure, a design tool for designing a turbomachinery blade of a gas turbine engine includes, embodied in one or more machine accessible storage media: a generalized polynomial chaos (gPC) module to develop, from test data resulting from simulations performed by high-fidelity aeromechanics models, probabilistic uncertainty estimates for vibratory stress and steady stress; and a probabilistic Goodman diagram generator to create a probabilistic Goodman diagram incorporating the probabilistic uncertainty estimates. An example 12 includes the subject matter of example 11, wherein the gPC module is to create a subset of the test data by non-random sampling and develop the probabilistic uncertainty estimates based on the subset of the test data. An example 13 includes the subject matter of example 11 or example 12, wherein the gPC module is to create a subset of the test data by executing a generalized polynomial chaos sampling method and develop the probabilistic uncertainty estimates based on the subset of the test data. An example 14 includes the subject matter of any of examples 11-13, including an uncertainty quantifier to determine a probability distribution function for vibratory stress based on the estimated vibratory stress and steady stress uncertainties. An example 15 includes the subject matter of any of claims 11-14, wherein the design tool is to generate a cumulative probability distribution function for vibratory stress. An example 16 includes the subject matter of any of claims 11-15, wherein the design tool is to predict a risk of failure of the turbomachinery blade design due to high cycle frequency based on the probabilistic Goodman diagram. An example 17 includes the subject matter of any of claims 11-16, wherein the design tool is to generate a reliability assessment for the turbomachinery blade design based on the probabilistic Goodman diagram. An example 18 includes the subject matter of any of claims 11-17, including a contour map generator to develop a probabilistic contour map from the probabilistic Goodman diagram.

In an example 19, according to at least one embodiment of this disclosure, a system for predicting high cycle fatigue failure of a turbomachinery blade includes: a generalized polynomial chaos (gPC) module to develop, from test data resulting from simulations performed by high-fidelity aeromechanics models, probabilistic uncertainty estimates for vibratory and steady stresses; a probabilistic Goodman diagram generator to create a probabilistic Goodman diagram incorporating the probabilistic uncertainty estimates; and a contour map generator to derive, from the probabilistic Goodman diagram, a probabilistic contour map indicating probabilities of high cycle fatigue failure resulting from different combinations of steady stress and vibratory stress in relation to a Goodman boundary. An example 20 includes the subject matter of example 19, wherein the gPC module is to create a subset of the test data by non-random sampling and develop the probabilistic uncertainty estimates based on the subset of the test data. An example 21 includes the subject matter of example 19 or example 20, wherein the gPC module is to create a subset of the test data by executing a generalized polynomial chaos sampling method and develop the probabilistic uncertainty estimates based on the subset of the test data. An example 22 includes the subject matter of any of examples 19-21, including an uncertainty quantifier to determine a probability distribution function for vibratory stress based on the estimated vibratory stress and steady stress uncertainties. An example 23 includes the subject matter of any of examples 19-22, wherein the computing device is to generate a cumulative probability distribution function for vibratory stress. An example 24 includes the subject matter of any of examples 19-23, wherein the computing device is to predict a risk of failure of the turbomachinery blade design due to high cycle frequency based on the probabilistic Goodman diagram. An example 25 includes the subject matter of any of examples 19-24, wherein the computing device is to generate a reliability assessment for the turbomachinery blade design based on the probabilistic Goodman diagram.

### BRIEF DESCRIPTION OF THE DRAWINGS

This disclosure is illustrated by way of example and not by way of limitation in the accompanying figures. The figures may, alone or in combination, illustrate one or more embodiments of the disclosure. Elements illustrated in the figures are not necessarily drawn to scale. Reference labels may be repeated among the figures to indicate corresponding or analogous elements.

FIG. 1 is a simplified block diagram of at least one embodiment of a computing system for probabilistically evaluating a turbomachinery component for risk of failure due to high cycle fatigue, as disclosed herein;

FIG. 2 is a simplified module diagram illustrating at least one embodiment of an environment that may be established during operation of the computing system of FIG. 1;

FIG. 3 is a simplified flow diagram of at least one embodiment of method for probabilistically evaluating a turbomachinery component for risk of failure due to high cycle fatigue, which may be executed by the computing system of FIG. 1;

FIG. 4 is a simplified example of a probabilistic Goodman Diagram, which may be created by the computing system of FIG. 1 as disclosed herein; and

FIG. 5 is a simplified example of a probabilistic contour map, which may be created by the computing system of FIG. 1 as disclosed herein; and

FIG. 6 is a simplified example of a user interface screen that may be produced by the computing system of FIG. 1, as disclosed herein.

### DETAILED DESCRIPTION OF THE DRAWINGS

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

Forced response analysis can be used to assess the design feasibility of turbomachinery components, such as fan, compressor and turbine blades or fan, compressor or turbine blisks for a gas turbine engine, for high cycle fatigue (HCF). To do this, a material limit boundary set by the Goodman Diagram envelope can be used, which combines the effects of steady stress and vibratory stress (also referred to as alternating stress). Existing approaches to this type of analysis are computationally expensive and time consuming. As a result, current approaches are performed deterministically and do not correlate the results of material testing and specimen testing, which are performed using high-fidelity aeromechanics models, with the forced response analysis. Rather, in the traditional deterministic approaches, system uncertainty (e.g., engine operating point, temperature distribution, mistuning, etc.) and material variability are accounted for by the use of conservative safety factors, leading to bulky designs. Further, the existing techniques are usually performed at the end of the component design process, when it is more costly to make significant changes to the blade geometry or aerodynamic design. Additionally, the existing deterministic approaches do not provide a calculated (e.g., mathematically rigorous) risk of HCF failure.

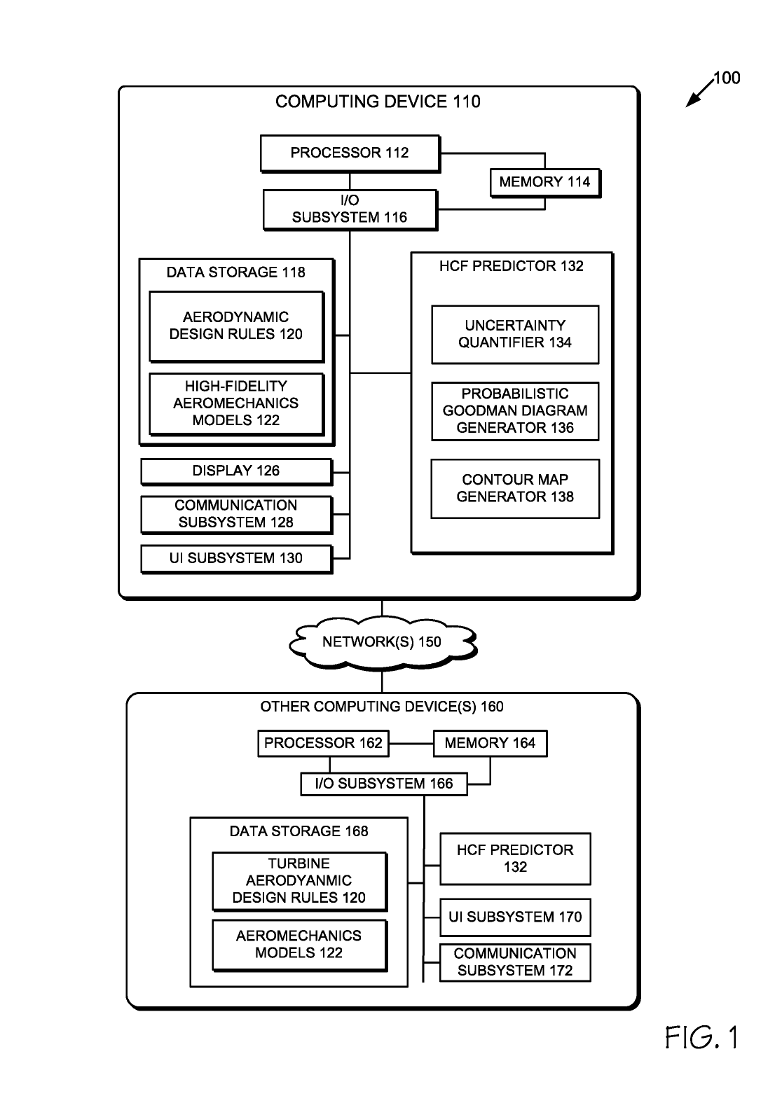

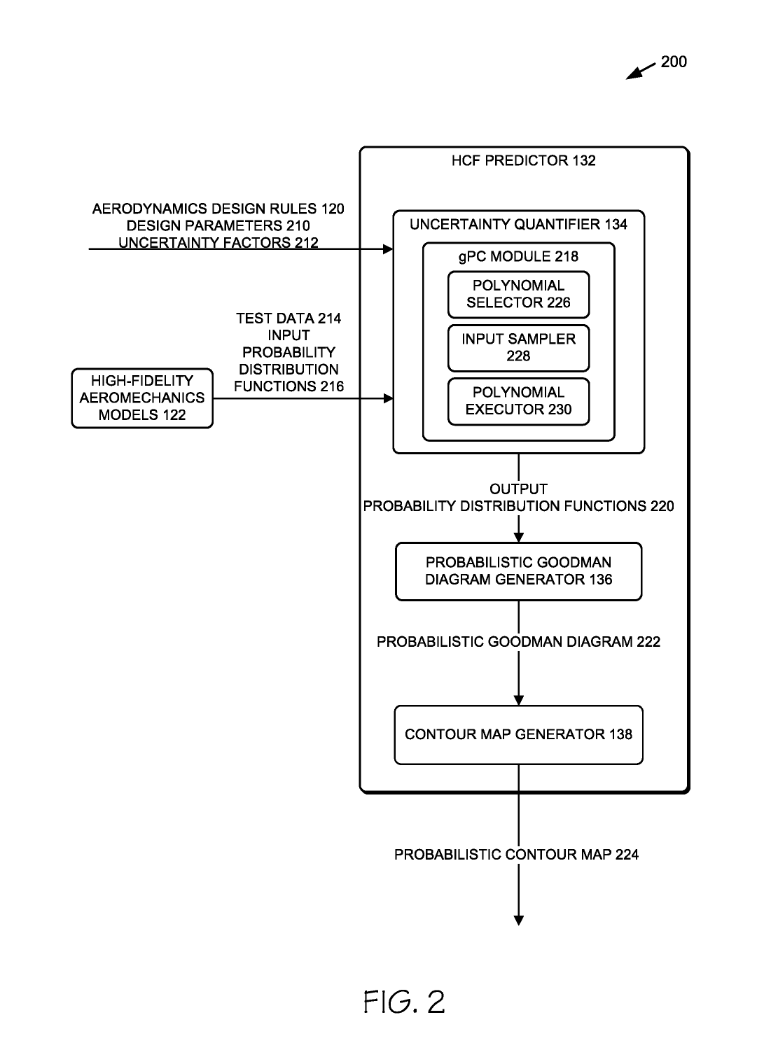

Embodiments of the techniques disclosed herein can obtain probabilistic forced response results accurately and affordably using high-fidelity tools. The probabilistic forced response results can be used to assess risk to a new engine design or calculate fleet reliabilities. Referring now to FIGS. 1-2, in a computing system 100, a high cycle fatigue (HCF) predictor 132 includes an uncertainty quantifier 134, which utilizes an uncertainty quantification methodology to generate output probability distribution functions (PDFs) 220 for steady stress and vibratory stress. The output PDFs 220 correlate test data 214, which include aeromechanics-related data values that are obtained using high-fidelity computational models 122, with a forced response analysis. The output PDFs 220 are used to provide a calculated likelihood of failure of a turbomachinery component (e.g., a turbine blade or turbine blisk) due to high cycle fatigue.

The illustrative uncertainty quantifier 134 includes a gPC module 218, which applies a generalized polynomial chaos (gPC) method to sample the test data 214 and construct polynomial approximations of the resulting steady and vibratory stresses. The disclosed application of the gPC method enables the HCF predictor 132 to accelerate the process of determining the probabilities of HCF failure based on the long-running simulations that are conducted using the high-fidelity aeromechanics models 122. For example, embodiments of the gPC module 218 can achieve, with a relatively small number of samples (e.g., on the order of 100× smaller sample size), fast rates of convergence and high accuracy in describing the input probability distributions 216 without loss of detail in the tails of the distribution. The output probability distribution functions 220 produced by the gPC module 218 are used by a probabilistic Goodman diagram generator 136 to create a probabilistic Goodman diagram 222, which is believed to be the first of its kind created using high-fidelity aeromechanics for turbomachinery components in an industry-level turbomachinery application. A contour map generator 138 creates a probabilistic contour map 224 from the probabilistic Goodman diagram 222. Among other things, the probabilistic Goodman diagram 222 and/or the contour map 224 may be used by, for example, turbine blade designers, in order to make better-informed design decisions. Alternatively or in addition, the probabilistic Goodman diagram 222 and/or the contour map 224 may be used by, for example, an aeromechanics expert, to assess the risk associated with high cycle fatigue, for any mode crossing (a potential source of resonant vibration), based on high fidelity, historically long-running simulations, and at a low computational cost.

In this way, embodiments of the HCF predictor 132 can, among other things: facilitate early-phase turbomachinery component design optimization that is informed by high-fidelity aeromechanics analyses, in order to subsequently provide probabilistic failure information that can be used to compute, e.g., fleet life reliability estimations that account for the risk of HCF failures. As such, embodiments of the HCF predictor 132 can, among other things: accelerate the usability and impact of high-fidelity aeromechanics analyses in the design process; and/or provide a process for optimizing a baseline turbomachinery design and for using uncertainty quantification techniques to present forced response results probabilistically; and/or utilize the uncertainty estimates (e.g., probability distribution function curves) for the steady and vibratory stresses to provide non-deterministic results, such as probabilities of failure and level of risk (as opposed to the existing standard of a “Pass/Fail” deterministic assessment).

Referring now in more detail to FIG. 1, an embodiment of the computing system 100, which is adapted to probabilistically evaluate a turbomachinery component (e.g., a turbine blade or blisk) design for risk of failure due to high cycle fatigue, is shown. The illustrative computing system 100 includes at least one computing device 110, which has embodied therein the HCF predictor 132, including the uncertainty quantifier 134, the probabilistic Goodman diagram generator 136, and the contour map generator 138. The computing device 110 includes hardware and/or software components that are capable of performing the functions disclosed herein, including the functions of the HCF predictor 132, the uncertainty quantifier 134, the probabilistic Goodman diagram generator 136, and the contour map generator 138. As shown, the computing system 100 may include one or more other computing devices 160 (e.g., servers, mobile computing devices, etc.), which may be in communication with each other and/or the computing device 110 via one or more communication networks 150, in order to perform one or more of the disclosed functions. The illustrative computing device 110 includes at least one processor 112 (e.g. a controller, microprocessor, microcontroller, digital signal processor, etc.), memory 114, and an input/output (I/O) subsystem 116. The computing device 110 may be embodied as any type of computing device such as a desktop computer, laptop computer, or mobile device (e.g., a tablet computer or smart phone), a server, an enterprise computer system, a network of computers, a combination of computers and other electronic devices, or other electronic devices. Although not specifically shown, it should be understood that the I/O subsystem 116 typically includes, among other things, an I/O controller, a memory controller, and one or more I/O ports. The processor 112 and the I/O subsystem 116 are communicatively coupled to the memory 114. The memory 114 may be embodied as any type of suitable computer memory device (e.g., volatile memory such as various forms of random access memory).

The I/O subsystem 116 is communicatively coupled to a number of hardware and/or software components, including a data storage device 118, a display 126, a communication subsystem 128, a user interface subsystem 130, and the HCF predictor 132. The data storage device 118 may include one or more hard drives or other suitable persistent data storage devices (e.g., flash memory, memory cards, memory sticks, and/or others). Turbomachinery aerodynamic design rules 120, aeromechanics models 122, and/or other data (e.g., the probabilistic Goodman diagram 222 and/or the contour map 224), or portions thereof, may reside at least temporarily in the data storage device 118 and/or other data storage devices of the computing system 100 (e.g., data storage devices that are “in the cloud” or otherwise connected to the computing device 110 by a network 150, such as a data storage device 168 of another computing device 160). Portions of the HCF predictor 132 may reside at least temporarily in the data storage device 118 and/or other data storage devices 168 that are part of the computing system 100. Portions of the turbine aerodynamic design rules 120, aeromechanics models 122, and/or other data (e.g., the probabilistic Goodman diagram 222 and/or the contour map 224), and/or the HCF predictor 132 may be copied to the memory 114 during operation of the computing device 110, for faster processing or other reasons.

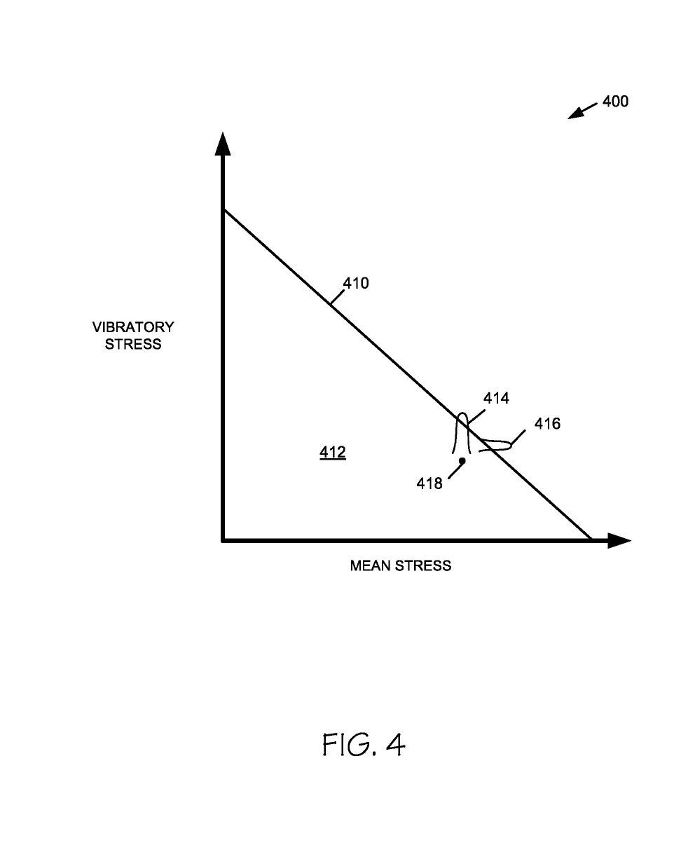

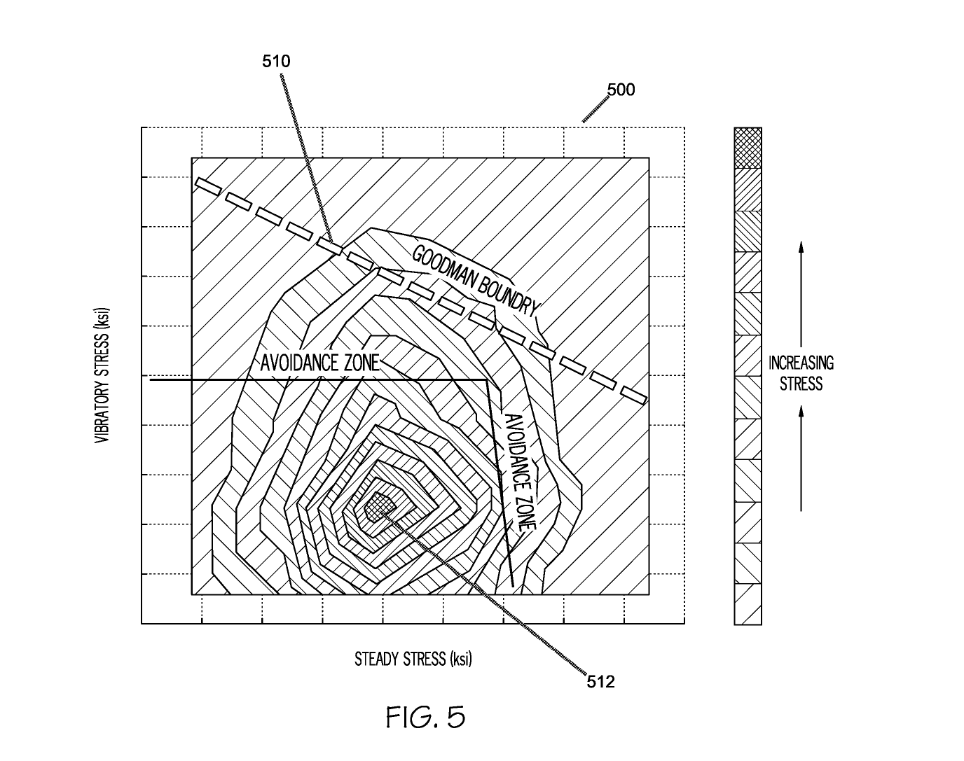

The display 126 may be embodied as any suitable type of digital display device, such as a liquid crystal display (LCD), and may include a touchscreen. The illustrative display 126 is configured or selected to be capable of displaying two- and/or three-dimensional graphics, including graphical plots and maps, such as the examples shown in FIGS. 4-5. The communication subsystem 128 may communicatively couple the computing device 110 to other computing devices and/or systems 160 by the network(s) 150. The network(s) 150 may be embodied as, for example, a cellular network, a local area network, wide area network (e.g., Wi-Fi), personal cloud, virtual personal network (e.g., VPN), enterprise cloud, public cloud, Ethernet, and/or public network such as the Internet. The communication subsystem 128 may, alternatively or in addition, enable shorter-range wireless communications between the computing device 110 and other computing devices 160, using, for example, BLUETOOTH and/or Near Field Communication (NFC) technology. Accordingly, the communication subsystem 128 may include one or more optical, wired and/or wireless network interface subsystems, cards, adapters, or other devices, as may be needed pursuant to the specifications and/or design of the particular computing device 110. The user interface subsystem 130 includes one or more user input devices (e.g., the display 126, a microphone, a touchscreen, keyboard, virtual keypad, etc.) and one or more output devices (e.g., audio speakers, LEDs, additional displays, etc.).

Each of the other computing devices 160 is embodied to include hardware and/or software components similar to those described above with reference to the computing device 110. For instance, components of the other computing devices 160 having the same name as components described above (e.g., processor 162 and processor 112, etc.) may be embodied in a similar way. Accordingly, for brevity, the description of those components is not repeated here.

The HCF predictor 132 and each of the subcomponents 134, 136, 138 is embodied as one or more computer-executable modules and/or data structures (e.g., computer hardware, software, or a combination thereof). The features and functions of the HCF predictor 132 and its subcomponents 134, 136, 138 are described in more detail below, with reference to FIG. 2. Particular aspects of the methods and analyses that may be performed by the various modules of the computing device 110 may vary depending on the component being analyzed and/or characteristics thereof. Accordingly, the examples described herein are illustrative and intended to be non-limiting. Further, the computing system 100 may include other components, sub-components, and devices not illustrated in FIG. 1 for clarity of the description. In general, the components of the computing system 100 are communicatively coupled as shown in FIG. 1 by electronic signal paths, which may be embodied as any type of wired or wireless signal paths capable of facilitating communication between the respective devices and components.

Referring now to FIG. 2, an environment 200 that may be created during operation of the computing device 110 (e.g., an execution or “runtime” environment) is shown. For example, the HCF predictor 132 may be invoked by a turbomachinery component designer or engineer to obtain a predicted risk of HCF failure for a particular set of design parameters 210, to evaluate a finalized component design for HCF failure risk, or to assess the reliability of an existing component that is already in operational use, based on a particular set of uncertainty factors 212, test data 214, and input probability distribution functions 216. The uncertainty factors 212 serve as random variables that are used by the uncertainty quantifier 134 to generate the output probability distribution functions 220 for vibratory stress and steady stress, and may include, for example, factors that are relevant for a specific application or mission of the turbomachinery component being analyzed. The test data 214 includes data values for each of the random variables 212 that are output by the high-fidelity aeromechanics models 122 in response to various inputs, such as various combinations of the design parameters 210. The input probability distribution functions 216 are PDFs that are associated with each of the random variables 212. The input PDFs 216 may be pre-specified or determined algorithmically based on the test data 214. As a simplified example, if the random variables 212 are engine speed, elastic modulus, and modal damping, the corresponding input PDFs 216 may be normal, uniform, and normal, respectively.

The HCF predictor 132 determines or obtains the design parameters 210, random variables 212, test data 214, and input PDFs 216 by any suitable input or data communication mechanism, whether user-initiated or an automated process. For example, the design parameters 210, random variables 212, test data 214, and/or input PDFs 216 may be obtained by the processor 112 accessing the memory 114 or the data storage 118, by interfacing with the communication subsystem 128, or by communicating with the user interface subsystem 130. The design parameters 210 may include, for example, information about the geometry and/or aerodynamics of the turbomachinery component being analyzed, and may include the aerodynamic design rules 120. The uncertainty factors 212 may include, for example, engine speed, elastic modulus (e.g., Young's modulus), engine operating point, temperature distribution, mistuning information, material variability, and/or modal damping factors. In some embodiments, a subset of the uncertainty factors 212 is selected by the HCF predictor 132 (e.g., in response to user input or by an automated process) for use in computing estimated vibratory and steady stress values for the forced response analysis. For example, in some embodiments, the number of random variables 212 used by the HCF predictor is in the range of integers including 3 and 12 and may include at least engine speed, elastic modulus and modal damping.

The illustrative uncertainty quantifier 134 uses the gPC module 218 to predict the probabilistic responses of the vibratory and steady stresses in view of the uncertainty factors 212, for a given set of design parameters 210. The illustrative gPC module 218 includes a polynomial selector module 226, an input sampler module 228, and a polynomial executor module 230. The illustrative polynomial selector 226 selects polynomial functions to be used to perform the gPC method for vibratory stress and steady stress, according to the input probability distribution function 216 associated with each random variable 212. For example, if the random variable “engine speed” has an input PDF of “normal,” the polynomial selector module 226 may select a different polynomial to approximate vibratory stress than if the input PDF for engine speed were “uniform.” Further, different polynomial functions may be applied for each of the vibratory stress and steady stress determinations. Some examples of orthogonal polynomials are Hermite, Jacobi, and Legendre, which correspond to PDF shapes for Gaussian, Beta and Uniform distributions.

The illustrative input sampler module 228 of the gPC module 218 obtains non-random samples of the test data 214 for each of the random variables 212. That is, rather than creating the output PDFs 220 on all of the test data 214, the input sampler module 228 selects a subset of the test data 214 (e.g., 10 samples of test data 214 for each of the random variables 212). The subset of test data 214 is then used by the polynomial executor module 230 to obtain polynomial approximations of the steady and vibratory stresses that correspond to the selected combinations of input values 214. As an example, if the uncertainty quantifier 134 is configured to utilize three random variables, a set of test data 214 includes a data value for each of the random variables (e.g., x1, x2, x3). To perform the sampling, the gPC module 218 may derive the sampled set of test data 214 from an isotropic or anisotropic gPC tensor product or sparse quadrature grids.

For each random variable 212, the polynomial executor 230 executes the polynomial functions selected by the polynomial selector 226 (based on the input PDF 216) with the input data values x1, x2, x3 to obtain output values yA and yB (for vibratory stress and steady stress). The gPC module 218 repeats this process for each of the samples of test data 214. For instance, if the input sampler 228 obtains 10 samples of test data 214 for each of three random variables, the gPC module 218 will repeat the polynomial approximation 10 times (one time for each combination of three input data values) for each of vibratory stress and steady stress. To develop the output PDFs 220, the uncertainty quantifier 134 can plot the output data values (e.g., yA1 to yA10, yB1 to yB10) as a histogram, and derive the output PDF 220 from the histogram (using, e.g., Monte Carlo simulation).

In this way, the gPC module 218 applies a generalized polynomial chaos mathematical technique using sampling methods and polynomial approximations to quantify the uncertainties in a turbomachinery component design as reflected in the output of long-running simulations that are executed by the high fidelity aeromechanics models 122. In some embodiments, the output of the gPC module 218 may include, for example, statistical moments (e.g., mean, standard deviation, skew), sensitivities, and probability distribution function shapes.

In some embodiments, the output of the gPC module 218 (e.g., the probability distribution function shapes) may be used by the uncertainty quantifier 134 or the gPC module 218 to construct “surrogate” aeromechanics models 122 that can be used to solve a design optimization problem using the aerodynamic design rules 120 as constraints, and thereby arrive at an “optimal” design for the turbomachinery component given the design parameters 210 and the constraints 120. Examples of the aeromechanics models 122 include high-fidelity mathematical models, such as computational models for steady and unsteady computational fluid dynamics (CFD), three-dimensional (3D) finite element analysis (FEA), and forced response analysis models.

Using the initial design and an “optimized” design, the uncertainty quantifier 134 can produce a cumulative distribution function (CDF) for the vibratory and steady stresses, which indicates the likelihood that a data value for a random variable with a given probability distribution will be found at a value less than or equal to (or conversely, exceed) a specified value, such as an amount of vibratory stress that is highly likely to lead to HCF failure. For example, the CDF can indicate a probability that vibratory stress experienced by a turbomachinery component of a particular design will be less than or equal to (or conversely, exceed) a baseline value recorded during actual component testing. As another example, the uncertainty quantifier 134 can estimate the probabilistic likelihood that a discrepancy between an actual observed test result (e.g., vibratory stress value) and a predicted test result will be within a specified degree of standard deviation. In this way, the CDF can give a mathematically-determined level of confidence in the predicted HCF failure risk that is produced by the HCF predictor 132 for a given set of design parameters 210. The CDFs can be obtained by, for example, integration of the baseline and optimal output PDFs 220.

Embodiments of the gPC module 218 can be implemented intrusively (e.g., embedded in a larger software application) or non-intrusively (e.g., as a plug-in). In some non-intrusive implementations, the gPC module 218 may use existing high fidelity aeromechanics software codes in a deterministic sense to calculate the coefficients of a pseudo-projection, and thereby avoid the effort required for analysis code rework. For example, the gPC module 218 may be implemented non-intrusively, e.g., as MATLAB code.

The illustrative probabilistic Goodman diagram generator 136 generates a probabilistic Goodman diagram 222. In materials science and fatigue analysis, the Goodman relation is an equation that can be used to quantify the interaction of mean and alternating stresses on the fatigue life of a material. As shown in the example of FIG. 4, the Goodman diagram is a graph of linear mean stress versus linear vibratory stress. The Goodman diagram can indicate a point (e.g., point 418) at which a material will fail under a particular combination of steady and vibratory stress, where the point 418 represents a particular combination of mean stress and vibratory stress that a turbomachinery component is likely to experience. In the example of FIG. 4, line 410 represents the (deterministic) Goodman line, and the area 412 underneath the Goodman line 410 represents combinations of design parameters that have an acceptable level of HCF risk, while the area above the Goodman line 410 represents combinations of design parameters that lead to an unacceptable level of HCF risk. The curves 414, 416 represent output probability distribution functions 220 for steady stress and vibratory stress, produced by the uncertainty quantifier 134.

The contour map generator 138 creates a probabilistic contour map 224, such as the example shown in FIG. 5, by combining the probability distribution functions 220 developed by the uncertainty quantifier 134 into a joint probability distribution plot in which a Goodman line 510 (e.g., the design “pass/fail” line) is also shown. In the example shown in FIG. 5, the high end of the contour scale, denoted by element 512, shows the region of maximum probability of steady and vibratory stress occurrence. That is, the region 512 depicts a region of the maximum likelihood of a particular turbomachinery component design experiencing particular combinations of steady and vibratory stress, in contrast to the deterministic approach, which would plot this combination as a single point. In the illustrated example, there is enough margin with respect to the Goodman diagram boundary. Avoidance zones can also be indicated, as a way to assist in the design process to provide enough margin (lower risk) with respect to the Goodman boundary, on the contour map 500 as shown.

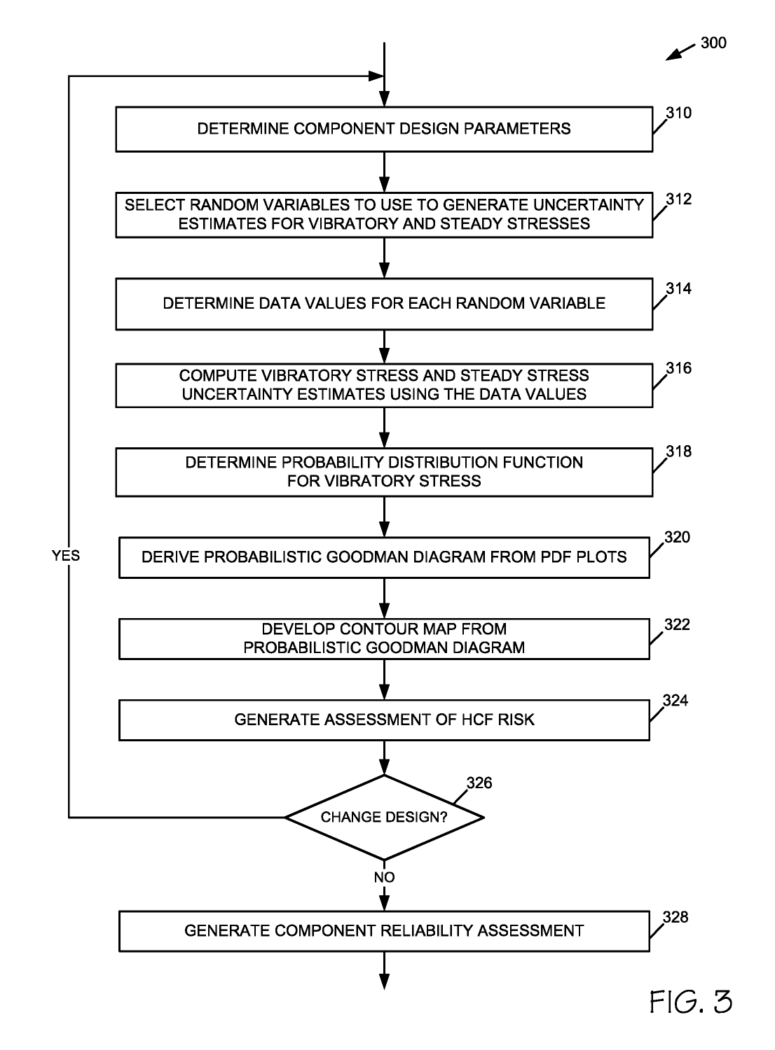

Referring now to FIG. 3, an illustrative method 300 for probabilistically evaluating a turbomachinery component for risk of failure due to high cycle fatigue is shown. Aspects of the method 300 may be embodied as computerized programs, routines, logic and/or instructions executed by the computing system 100, for example by one or more of the modules 134, 136, 138 of the HCF predictor 132, alone or in combination with other components of the computing system 100. Aspects of the method 300 may be performed online or offline as may be needed or desired, according to the requirements or implementation of a particular embodiment of the computing system 100. At block 310, the computing system 100 determines the design parameters 210 for the turbomachinery component being analyzed (e.g., a turbine blade or blisk). The design parameters 210 determined at block 310 may represent a “baseline” design, an iteration of a baseline design, or an “optimized” design of the turbomachinery component, for example. In other words, the method 300 may be performed iteratively until an acceptable level of HCF risk is achieved, in some embodiments. The computing system 100 may obtain the design parameters 210 by, for example, the user interface subsystem 130 or the communication subsystem 128.

At block 312, the computing system 100 selects the random variables (e.g., the uncertainty factors 212) to use to generate uncertainty estimates to be applied to vibratory and steady stresses in a forced response analysis. The computing system 100 may select the random variables based on, for example, one or more of the design parameters 210. The random variables may correspond to parameters of one or more high-fidelity aeromechanics models 122 used in the forced response analysis (e.g., steady and unsteady computational fluid dynamics models, and finite element analysis models). At block 314, the computing system 100 determines the data values for each of the random variables. To do this, the computing system 100 executes simulations using the aeromechanics models 122. The computing system 100 applies the gPC sampling techniques described above to the output (e.g., test data 214) of the simulations to accelerate convergence.

Using the test results from the executed simulations, at block 316, the computing system 100 computes the uncertainty estimates for vibratory stress and steady stress using polynomial approximation as described above. To do this, the computing system 100 selects, for each random variable, a polynomial function based on the probability distribution function for the random variable, and computes the result of the polynomial function for the sampled input values using, for example, stochastic collocation, spectral projection or alternate approaches described as part of the overall gPC process. The output of the polynomial functions is plotted as a histogram, which is then used to develop the output probability distribution function 220 for vibratory stress, at block 318. An output probability distribution function 220 may similarly be developed for steady stress. At block 320, the computing system 100 derives the probabilistic Goodman diagram 222 from the output probability distribution functions 220 for vibratory stress and steady stress. At block 322, the computing system 100 develops the probabilistic contour map 224 from the probabilistic Goodman diagram 222, using the probability distribution functions for steady stress and vibratory stress. At block 324, the computing system generates an assessment of the risk of failure due to high cycle fatigue, by referring to either the probabilistic Goodman diagram 222 or the contour map 224. For example, the computing system 100 may map a set of data values for vibratory stress and steady stress to the contour map 224 to obtain an indication of the likelihood of HCF failure from the contour map 224. In FIG. 5, moving across the differently-patterned rings in a direction away from the point 512 implies decreasing likelihood of the alternating and mean stress combinations. However this also means that the areas of the contour map 224 that are further away from the point 512 correspond to designs that have a higher risk of HCF failure because of their proximity to the Goodman boundary.

At block 326, the computing system 100 may evaluate the HCF risk assessment obtained at block 324 to determine (or allow an end user to determine) whether to modify the design of the turbomachinery component (e.g., a turbine blade or blisk design). For example, if the risk of HCF failure determined at block 324 is greater than a pre-defined threshold level, the computing system 100 may determine that a design change is needed. If the computing system 100 determines that a design change is needed, the method 300 returns to block 310 and re-executes the method 300 with the new set of design parameters. If the computing system determines that no design change is needed, the computing system 100 proceeds to block 328. At block 328, the computing system 100 may generate a reliability assessment for the design based on the design parameters determined at block 310, using the HCF risk assessment developed at block 324.

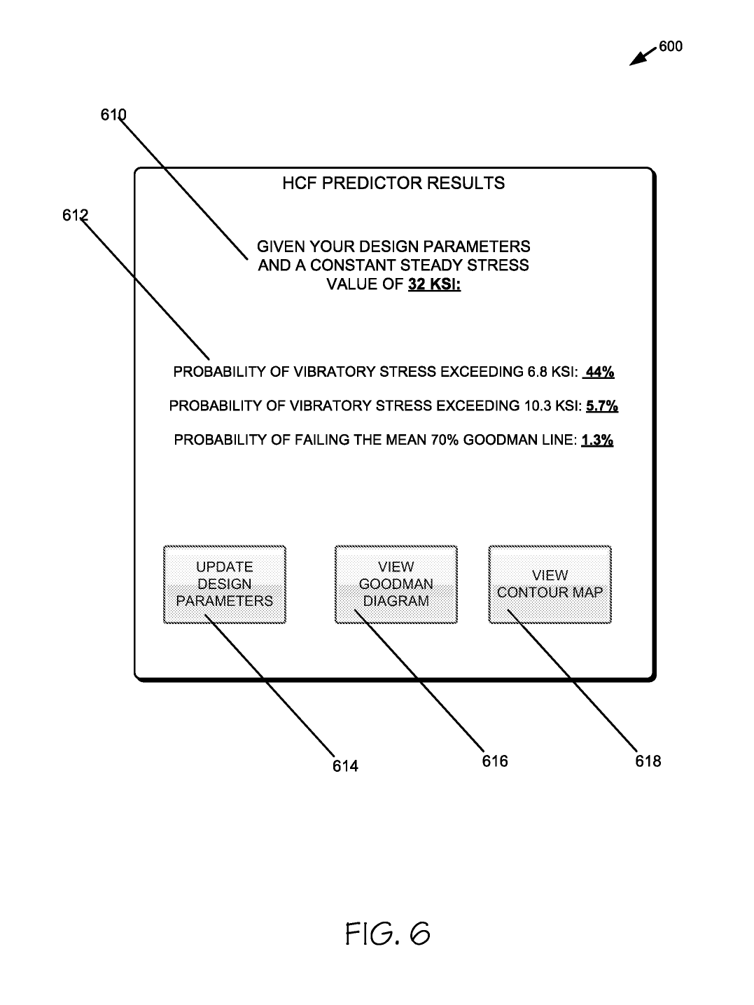

Referring now to FIG. 6, a simplified example of a user interface 600 that may be presented by the computing system 100 (e.g., by the display 126) is shown. The display indicates the input parameters at area 610, which include a constant steady stress value of 32 ksi. The user interface 600 presents the results of the computations performed by the HCF predictor in area 612, which include cumulative probabilities of 44%, 5.7%, and 1.3%. The user interface 600 presents a number of illustrative user-selectable controls 614, 616, 618, which enable an end user of the computing system 100 (e.g., a turbomachinery component designer) to update the design parameters (control 614), view the probabilistic Goodman diagram 222 (control 616), or view the probabilistic contour map 224 (control 618), by selecting the corresponding control 614, 616, 618 (e.g., by touching or tapping a touch-sensitive portion of the display 126, by mouse click, etc.).

As an illustration of the operation of the HCF predictor 132, an engine core rig test was performed on an existing turboshaft engine to prove out the probabilistic forced response analysis disclosed herein on a high pressure high work single stage turbine blisk. As part of the engine core rig test, vibratory stress levels were recorded using strain gauge data from instrumented turbine blades. The engine rig test results show that the strain gauge that responded the most to the test recorded a vibratory stress of 10.3 kilopounds per square inch (ksi). A traditional (deterministic) forced response analysis calculated the same vibratory stress to be 7.6 ksi, indicating a discrepancy between the computed and observed values. With the probabilistic analysis as disclosed herein, the engine rig test results were ‘re-qualified’ to see if the probabilistic analysis would capture the 10.3 ksi observed on the engine rig test.

From the probability distribution function (PDF) and cumulative distribution function (CDF) generated for vibratory stress using the probabilistic techniques disclosed herein, the probability distributions showed that a value of 10.3 ksi had a small, but measurable likelihood of occurring. The engine rig test had a measured vibratory stress of 10.3 ksi, which seemed to be well above the best prediction available at the time. So, the probabilistic analysis disclosed herein appears capable of capturing differences between the predicted result for the baseline geometry and the observed test result given a thorough survey of input uncertainties. Analysis of the CDF of the vibratory stress for the optimized blade indicated a 5.7% probability of the vibratory stress being greater than or equal to 10.3 ksi.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation of the computing system 100.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

This disclosure is to be considered as exemplary and not restrictive in character, and all changes and modifications that come within the spirit of the disclosure are desired to be protected.

1. A method for evaluating a turbomachinery blade design for risk of high cycle fatigue, the method comprising, with at least one computing device:
selecting a plurality of random variables, each random variable corresponding to a parameter of a high-fidelity aeromechanics model;
for each selected random variable, creating a subset of test data, the test data resulting from simulations performed by the high-fidelity aeromechanics model;
estimating vibratory stress and steady stress uncertainties using the set of test data for each random variable; and
generating a probabilistic Goodman diagram incorporating the estimated uncertainties.

2. The method of claim 1, comprising creating the subset of test data by non-random sampling.

3. The method of claim 1, comprising creating the subset of test data by executing a generalized polynomial chaos sampling method.

4. The method of claim 1, comprising determining a probability distribution function for vibratory stress based on the estimated vibratory stress and steady stress uncertainties

5. The method of claim 1, comprising generating a cumulative probability distribution function for vibratory stress.

6. The method of claim 1, comprising predicting a risk of failure of the turbomachinery blade design due to high cycle frequency based on the probabilistic Goodman diagram.

7. The method of claim 1, comprising generating a reliability assessment for the turbomachinery blade design based on the probabilistic Goodman diagram.

8. The method of claim 1, comprising developing a probabilistic contour map from the probabilistic Goodman diagram.

9. A computing device comprising a processor and memory having stored therein a plurality of instructions that when executed by the processor cause the computing device to perform the method of claim 1.

10. One or more machine readable storage media comprising a plurality of instructions stored thereon that in response to being executed result in a computing device performing the method of claim 1.

11. A design tool for designing a turbomachinery blade of a gas turbine engine, the design tool comprising, embodied in one or more machine accessible storage media:
a generalized polynomial chaos (gPC) module to develop, from test data resulting from simulations performed by high-fidelity aeromechanics models, probabilistic uncertainty estimates for vibratory stress and steady stress; and
a probabilistic Goodman diagram generator to create a probabilistic Goodman diagram incorporating the probabilistic uncertainty estimates.

12. The design tool of claim 11, wherein the gPC module is to create a subset of the test data by non-random sampling and develop the probabilistic uncertainty estimates based on the subset of the test data.

13. The design tool of claim 11, wherein the gPC module is to create a subset of the test data by executing a generalized polynomial chaos sampling method and develop the probabilistic uncertainty estimates based on the subset of the test data.

14. The design tool of claim 11, comprising an uncertainty quantifier to determine a probability distribution function for vibratory stress based on the estimated vibratory stress and steady stress uncertainties.

15. The design tool of claim 11, wherein the design tool is to generate a cumulative probability distribution function for vibratory stress.

16. The design tool of claim 11, wherein the design tool is to predict a risk of failure of the turbomachinery blade design due to high cycle frequency based on the probabilistic Goodman diagram.

17. The design tool of claim 11, wherein the design tool is to generate a reliability assessment for the turbomachinery blade design based on the probabilistic Goodman diagram.

18. The design tool of claim 11, comprising a contour map generator to develop a probabilistic contour map from the probabilistic Goodman diagram.

19. A system for predicting high cycle fatigue failure of a turbomachinery blade, the system comprising:
a generalized polynomial chaos (gPC) module to develop, from test data resulting from simulations performed by high-fidelity aeromechanics models, probabilistic uncertainty estimates for vibratory and steady stresses;
a probabilistic Goodman diagram generator to create a probabilistic Goodman diagram incorporating the probabilistic uncertainty estimates; and
a contour map generator to derive, from the probabilistic Goodman diagram, a probabilistic contour map indicating probabilities of high cycle fatigue failure resulting from different combinations of steady stress and vibratory stress in relation to a Goodman boundary.

20. The system of claim 19, wherein the gPC module is to create a subset of the test data by non-random sampling and develop the probabilistic uncertainty estimates based on the subset of the test data.

21. The system of claim 19, wherein the gPC module is to create a subset of the test data by executing a generalized polynomial chaos sampling method and develop the probabilistic uncertainty estimates based on the subset of the test data.

22. The system of claim 19, comprising an uncertainty quantifier to determine a probability distribution function for vibratory stress based on the estimated vibratory stress and steady stress uncertainties.

23. The system of claim 19, wherein the computing device is to generate a cumulative probability distribution function for vibratory stress.

24. The system of claim 19, wherein the computing device is to predict a risk of failure of the turbomachinery blade design due to high cycle frequency based on the probabilistic Goodman diagram.

25. The system of claim 19, wherein the computing device is to generate a reliability assessment for the turbomachinery blade design based on the probabilistic Goodman diagram.
